(19) United States
(12) Patent Application Publication
(10) Pub. No.: US 2014/0124435 A1
(43) Pub. Date: May 8, 2014

(54) SINGLE CUP BREWER DISPOSABLE FILTER AND BEVERAGE SYSTEM

(71) Applicant: Shawn Alpheus Jackson, Chevy Chase, MD (US)

(72) Inventor: Shawn Alpheus Jackson, Chevy Chase, MD (US)

(21) Appl. No.: 13/669,404

(22) Filed: Nov. 5, 2012

(51) Int. Cl. A47J 31/06

(52) U.S. Cl. 210/473

(57) ABSTRACT

A disposable filter can replace a reusable filter in a single cup brewer. The disposable filter can be removed immediately after use and discarded without mess, making the brewer available without delay for the next brew cycle. The disposable filter includes a basket portion having a collar, where the basket portion can fit into a coffee filter container of the brewer and the collar can rest over a lip of the coffee filter container.

### BACKGROUND OF THE INVENTION

The present invention relates to single cup beverage preparation accessories and, more particularly, to a disposable beverage filter compatible with a single cup brewer's reusable filter holder.

Beverages are often brewed as a single cup at a time with various single cup brewers, such as the Keurig K-cup single cup brewer. These single cup brewers can be used for brewing pre-packaged, preselected products such as coffee, tea and like product medium within non-biodegradable, non-compostable, and environmentally unfriendly plastic containers. Alternatively, these single cup brewers offer an environmentally friendly, reusable filter that can be used with the user's own coffee. These reusable filters, however, are prone to clogging (as identified by Boul, U.S. Pat. No. 8,221,813 B2), and can result in a slow and messy process, thereby defeating the expediency and convenience of using a single cup brewer.

FIG. 1 shows an exploded perspective view of a coffee filter system of a conventional single cup brewer. A coffee filter container 10 can hold a reusable coffee filter 14 and a coffee filter container cap 12 can fit over the reusable coffee filter 14 inside the coffee filter container 10. The flange/collar of the reusable coffee filter 14 serves as a gasket and seal between the coffee filter container 10 and the coffee filter cap 12 which serves to prevent leakage of water or coffee grounds.

After each use, and before the next brew cycle can be started, the coffee grounds must be removed from the filter. This process can be time consuming because the reusable filter is hot and difficult to handle. If allowed to cool, however, the used coffee grounds can become hard and compacted, requiring the filter to be tapped against a hard surface to release the grounds. This can result in damage to the filter. Additionally, used coffee grounds can be easily spilled onto countertops and floor surfaces and potentially clog drains if rinsed or discarded into sinks.

As can be seen, there is a need for an improved disposable filter system for single cup brewers.

### SUMMARY OF THE INVENTION

In one aspect of the present invention, a disposable beverage filter comprises a basket portion formed from a water permeable material having a ring-shaped opening thereto; and a collar disposed about an outer periphery of the ring-shaped opening of the basket portion, the collar fitting over an exterior opening of a coffee filter container cup of a single cup brewer.

In another aspect of the present invention, a disposable beverage filter comprises a basket portion formed from a water permeable material having a ring-shaped opening thereto; a collar attached to and disposed about an outer periphery of the ring-shaped opening of the basket portion, the collar fitting over an exterior opening of a coffee filter container cup of a single cup brewer; and a tab extending from the disposable beverage filter, wherein the tab extends from an inner edge of the collar and extends into the ring-shaped opening.

These and other features, aspects and advantages of the present invention will become better understood with reference to the following drawings, description and claims.

### BRIEF DESCRIPTION OF THE DRAWINGS

FIG. 1 is an exploded perspective view of a beverage filter assembly according to the prior art;

FIG. 2 is a an exploded perspective view of a beverage filter assembly according to an exemplary embodiment of the present invention;

FIG. 3 is a perspective view of a disposable beverage filter used in the beverage filter assembly of FIG. 2;

FIG. 4 is a side view of the disposable beverage filter of FIG. 3;

FIG. 5 is a top view of the disposable beverage filter of FIG. 3;

FIG. 6 is a perspective view of a disposable beverage filter having a tab according to an exemplary embodiment of the present invention;

FIG. 7 is a perspective view of the disposable beverage filter showing an exemplary demarcation line showing how different materials may be used to create the basket portion of the disposable beverage filter;

FIG. 8 is a side view of a disposable beverage filter showing two distinct chambers according to an exemplary embodiment of the present invention; and

FIG. 9 is a side view of a disposable beverage filter having product disposed therein with an optional sealing member according to an exemplary embodiment of the present invention.

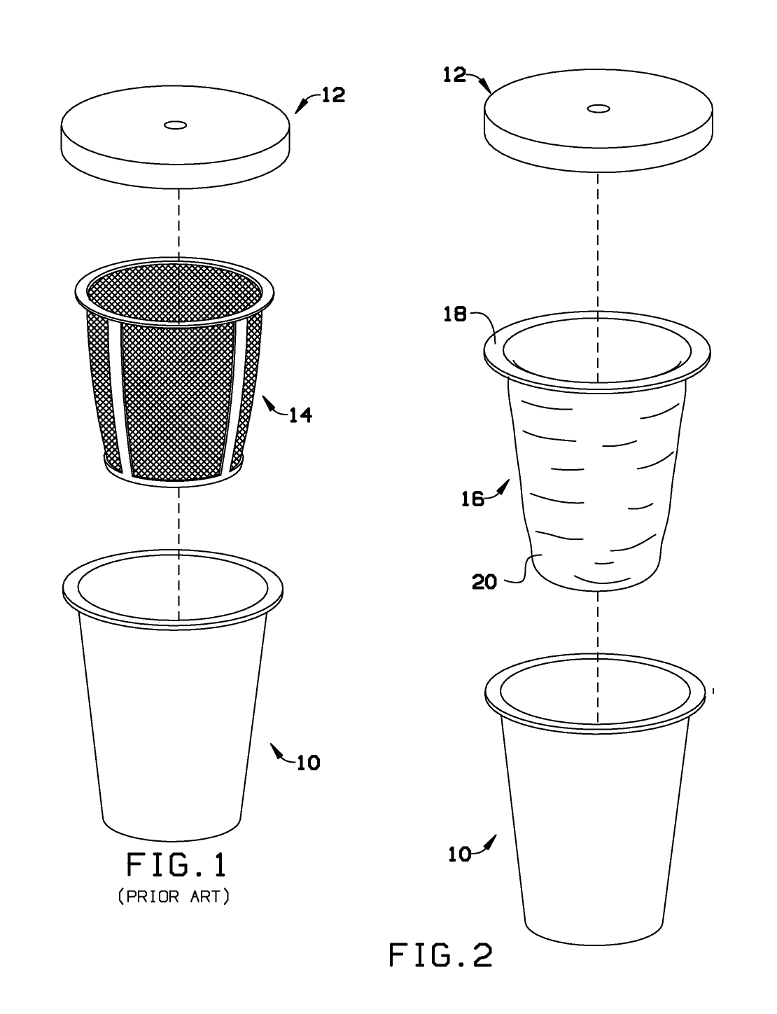

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a disposable filter that can replace a reusable filter in a single cup brewer. The disposable filter can be removed immediately after use and discarded without mess, making the brewer available without delay for the next brew cycle. The disposable filter includes a basket portion having a collar, where the basket portion can fit into a coffee filter container of the brewer and the collar can rest over a lip of the coffee filter container.

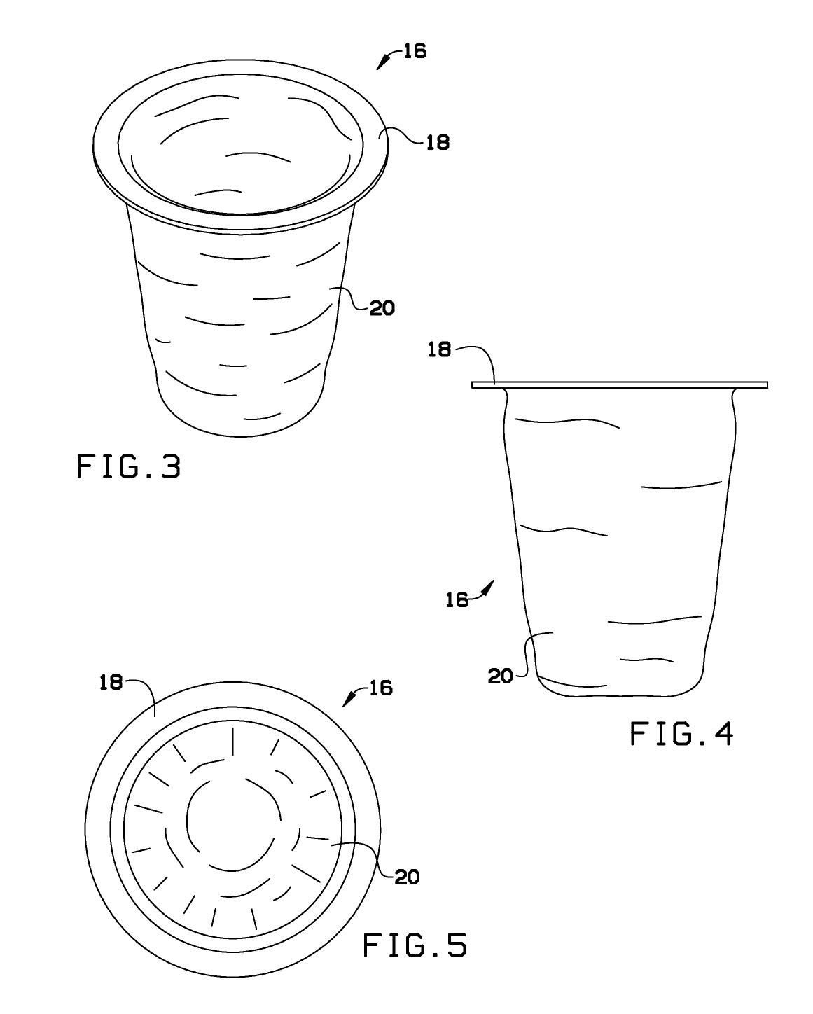

Referring to FIGS. 2 through 5, a disposable beverage filter 16 includes a basket portion 20 and a collar 18. Similar to the reusable beverage filter 14, described above, the disposable beverage filter 16 can be designed to be placed into a coffee filter container 10 of a single cup brewer (not shown). The coffee filter container cap 12 can fit over the coffee filter container 10 to prevent, by sealing with the collar 18, leakage of water or coffee grounds from the disposable beverage filter 16.

The basket portion 20 can be separately attached to the collar 18 or may be manufactured as a single unit. The basket portion 20 can be made of a water permeable material that will allow for the filtration of product medium, such as crepe paper, a natural mesh material, or the like. As described below, in some embodiments, the basket portion 20 can be made from two or more different materials attached together to form the basket portion 20.

The collar 18 can be formed of a resilient material so as to provide a gasket and seal between the coffee filter container 10 and the coffee filter container cap 12. The collar 18 can be made from, for example, multiple layers of the material forming the basket portion 20. The collar 18 can be made from other materials, provided that the basket portion 20 can attach thereto.

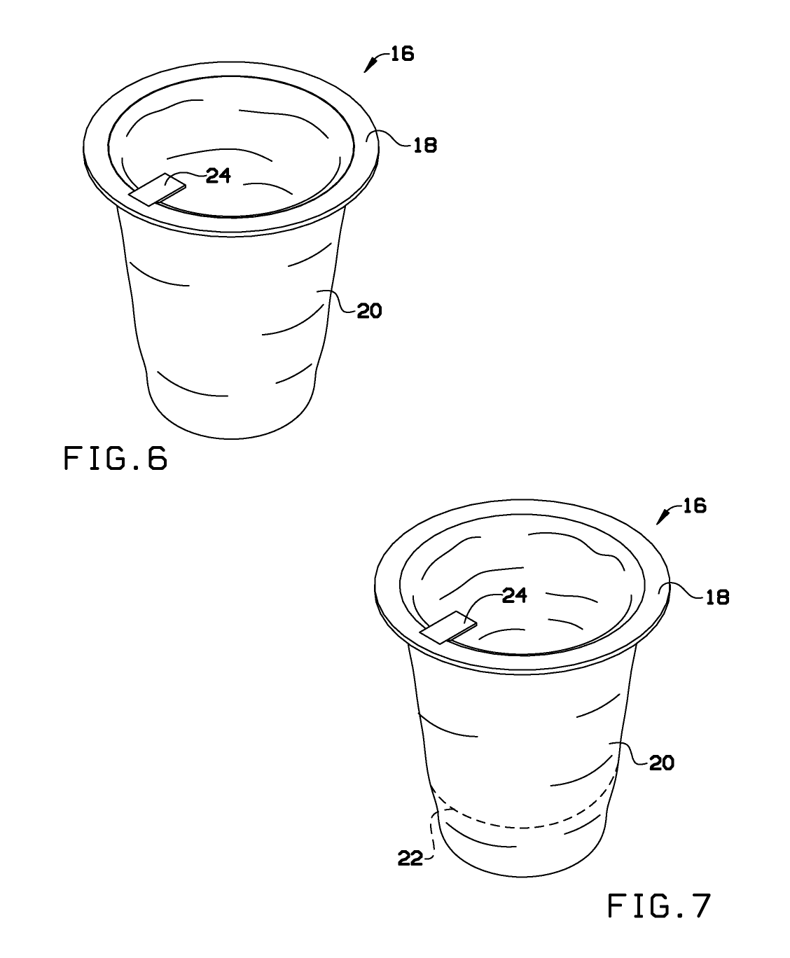

Referring now to FIG. 6, a tab 24 can be included on the disposable beverage filter 16. The tab 24 may extend from the disposable beverage filter 16 to permit a user to easily grasp the disposable beverage filter 16 and remove it from the coffee filter container 10. In some embodiments, the tab 24 can extend from the collar 18 toward an inside of the ring-shape of the collar 18. The tab 24 can be made from various materials, and may be the same or different material as that of the collar 18.

Referring to FIG. 7, the basket portion 20 may be formed from more than one material. A material line of demarcation 22 can indicate where two different materials connect together. The different materials may be designed for different applications. For example, for use with tea, a user may desire a less permeable material at a lower end of the basket portion 20 to provide the tea with steeping time. The different materials can be two different materials, different thicknesses of the same material, overlap of materials, or the like. Although the material line of demarcation 22 is shown at a particular location along the basket portion 20, the specific location of the material line of demarcation 22 can be located in various positions on the basket portion 20. Moreover, multiple materials and multiple material lines of demarcation 22 may be used in the basket portion 20.

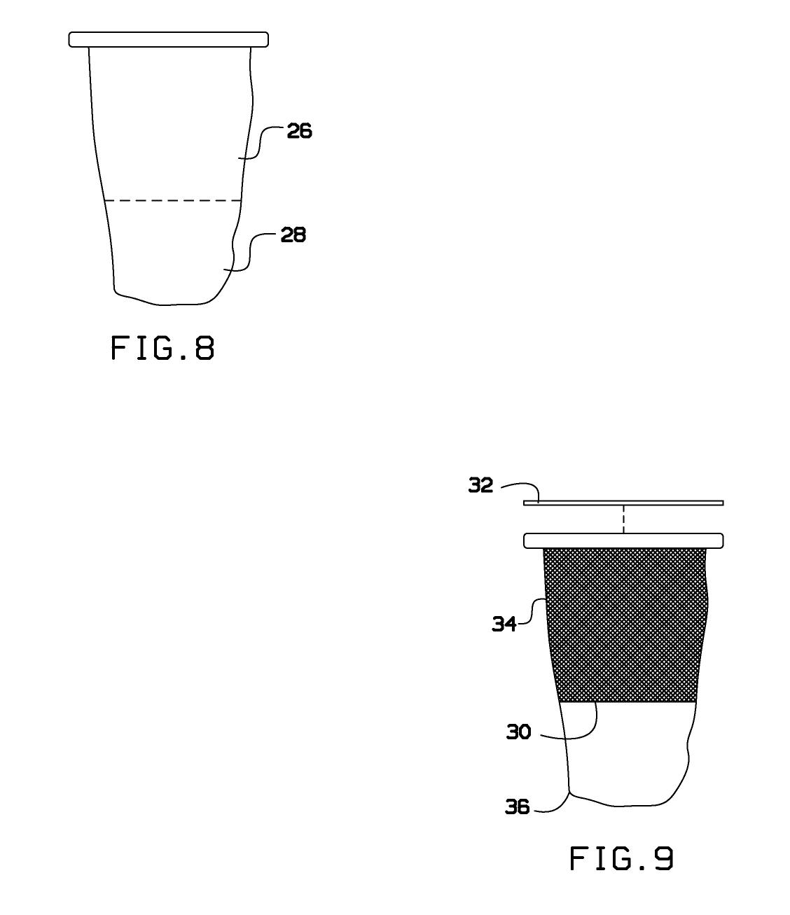

Referring now to FIG. 8, the basket portion 20 can be designed in two separate chambers, an upper chamber 26 and a lower chamber 28. The two chambers 26, 28 can be used for various purposes. For example, one chamber can be used to hold pre-packaged materials and a second chamber could be used to allow filtration or for some other purpose. In some embodiments, each chamber may include a different material, such as coffee grounds in one chamber and a flavoring or non-dairy creamer in another chamber. The material for each chamber 26, 28 may be the same or different. Although the upper chamber 26 and the lower chamber 28 are shown at a particular configuration to form the basket portion 20, the relative size (proportion relative to the size of the entire basket portion 20) of each of the upper and lower chambers 26, 28 can vary. Moreover, additional chambers can be contemplated within the scope of the present invention.

Referring to FIG. 9, the basket portion can include two different chambers, an upper chamber 34 and a lower chamber 36 separated by a base material 30. The base material 30 may be, for example, a paper-based material or a compostable corn-based material, a natural mesh material, or the like. One of the chambers 34, 36 can be filled with product. For example, as shown in FIG. 9, the upper chamber 34 may include product, such as coffee. In this configuration, the pre-packaged product can be agitated in the upper chamber, possibly flow controlled, and the extracted liquid can flow to the lower chamber and then out of the coffee filter container 10. In some embodiments, the lower chamber 36 may include product. In this configuration, water can enter the empty upper chamber and flow through the pre-packaged product in the lower chamber.

A freshness seal 32 can be provided to cover the ring-shaped opening formed by the collar 18. The freshness seal 32 can be made from various materials, including one or more of paper, corn-based products, foil, plastic or the like.

The disposable beverage filter 16 can be packaged in various forms. For example, the disposable beverage filter 16 can be stacked together or may be pressed flat for a user to push open the filter basket portion 20. In some embodiments, the disposable beverage filter 16 may be compressed and inserted into a packet similar to that of a typical tea bag, for example.

It should be understood, of course, that the foregoing relates to exemplary embodiments of the invention and that modifications may be made without departing from the spirit and scope of the invention as set forth in the following claims.

1. A disposable beverage filter comprising:
a basket portion formed from a water permeable material having a ring-shaped opening thereto; and
a collar attached directly to and disposed about an outer periphery of the ring-shaped opening of the basket portion, the collar fitting directly between an exterior opening of a separate and unattached coffee filter container cup of a single cup brewer and a coffee filter container cap.

2. The disposable beverage filter of claim 1, wherein the collar and the basket portion are formed as an integral unit.

3. The disposable beverage filter of claim 1, wherein the collar and the basket portion are formed separately and joined together.

4. The disposable beverage filter of claim 1, further comprising a tab extending from the disposable beverage filter.

5. The disposable beverage filter of claim 4, wherein the tab extends from an inner edge of the collar and extends into the ring-shaped opening.

6. The disposable beverage filter of claim 1, wherein the basket portion includes at least two different materials forming different portions of the basket portion.

7. The disposable beverage filter of claim 1, wherein the basket portion includes a first chamber separated from a second chamber.

8. The disposable beverage filter of claim 7, wherein at least one of the first chamber and the second chamber includes a pre-packaged product.

9. The disposable beverage filter of claim 1, further comprising a freshness seal disposed over the ring-shaped opening.

10. A disposable beverage filter comprising:
a basket portion formed from a water permeable material having a ring-shaped opening thereto;
a collar attached directly to and disposed about an outer periphery of the ring-shaped opening of the basket portion, the collar fitting directly between an exterior opening of a separate and unattached coffee filter container cup of a single cup brewer and a coffee filter container cap; and
a tab extending from the disposable beverage filter, wherein
the tab extends from an inner edge of the collar and extends into the ring-shaped opening.

11. The disposable beverage filter of claim 10, wherein the basket portion includes at least two different materials forming different portions of the basket portion.

12. The disposable beverage filter of claim 10, wherein the basket portion includes a first chamber separated from a second chamber.

13. A disposable beverage filter comprising:
a basket portion formed from a water permeable material having a ring-shaped opening thereto, the basket portion permitting liquid to flow out therefrom and directly into a separate coffee filter container cup of a single cup brewer; and
a collar disposed about and formed directly on an outer periphery of the ring-shaped opening of the basket portion, the collar fitting directly between an exterior opening of the coffee filter container cup of the single cup brewer and a coffee filter container cap.

14. The disposable beverage filter of claim 13, wherein the collar and the basket portion are formed as an integral unit.

15. The disposable beverage filter of claim 13, wherein the collar and the basket portion are formed separately and joined together.

16. The disposable beverage filter of claim 13, further comprising a tab extending from the disposable beverage filter.

17. The disposable beverage filter of claim 15, wherein the tab extends from an inner edge of the collar and extends into the ring-shaped opening.
